(19) United States
(12) Patent Application Publication
(10) Pub. No.: US 2018/0105067 A1
(43) Pub. Date: Apr. 19, 2018

(54) VEHICLE SEAT PLACEMENT STRUCTURE AND VEHICLE

(71) Applicant: TOYOTA JIDOSHA KABUSHIKI KAISHA, Toyota-shi (JP)

(72) Inventor: Satoshi AJISAKA, Okazaki-shi (JP)

(73) Assignee: TOYOTA JIDOSHA KABUSHIKI KAISHA, Toyota-shi (JP)

(21) Appl. No.: 15/717,086

(22) Filed: Sep. 27, 2017

(30) Foreign Application Priority Data
Oct. 13, 2016 (JP) 2016-201994

(51) Int. Cl. B60N 2/01; B60N 2/14; B60N 2/20; B60N 2/02

(52) U.S. Cl. CPC B60N 2/012; B60N 2/14; B60N 2002/0055; B60N 2/0232; B60N 2/20

(57) ABSTRACT

A vehicle seat placement structure and vehicle are obtained capable of securing space for respective occupants seated on a driver seat and on rear seats, and securing comfort of the occupants. In a vehicle cabin of the vehicle, a pair of seats are each disposed adjacent to a first seat such that seat cushions of the pair of seats do not overlap the seat cushion of the first seat as viewed along the vehicle width direction. This enables a driver seated in the first seat and occupants seated in the pair of seats to be seated such that at least the upper body of the driver and the upper bodies of the occupants do not overlap each other as viewed along the vehicle width direction.

### CROSS-REFERENCE TO RELATED APPLICATION

This application is based on and claims priority under 35 USC 119 from Japanese Patent Application No. 2016-201994 filed on Oct. 13, 2016, the disclosure of which is incorporated by reference herein.

### BACKGROUND

### Technical Field

The present disclosure relates to a vehicle seat placement structure and a vehicle.

### Related Art

Japanese Patent Application Laid-Open (JP-A) No. 2008-30517 (Patent Document 1) describes an invention related to a vehicle body structure. In this vehicle body structure, a driver seat, and rear seats that are respectively disposed at both vehicle width direction sides at a vehicle rear of the driver seat are disposed such that a rear section of a seat cushion of the driver seat and a front section of a seat cushion of each rear seat overlap each other as viewed along the vehicle width direction. Thus, the driver seat and the rear seats can be disposed close to each other. As a result, a front-rear length of an interior cabin space can be prevented from becoming large while securing the number of occupants who can ride in the vehicle.

However, in the related art described in Patent Document 1, in addition to the positional relationship between the driver seat and the rear seats as described above, the driver seat and the rear seats are disposed close together in the vehicle width direction. Thus, it is conceivable that insufficient space is secured for each of a driver seated on the driver seat and occupants seated on the rear seats, impairing occupant comfort.

### SUMMARY

In consideration of the above circumstances, an object of the present disclosure is to obtain a vehicle seat placement structure and a vehicle capable of securing space for respective occupants seated on a driver seat and rear seats such that the comfort of occupants is secured.

A vehicle seat placement structure according to a first aspect includes a first seat and a pair of second seats. The first seat includes a first seat cushion on which a driver sits and a first seatback configured to support the back of a driver, with the first seat disposed centrally in a vehicle width direction inside a vehicle cabin. The pair of second seats each include a second seat cushion on which an occupant sits and a second seatback configured to support the back of an occupant, are disposed at a vehicle rear of the first seat so as to be separated from each other in the vehicle width direction, and are each disposed adjacent to the first seat such that the second seat cushion does not overlap the first seat cushion as viewed along the vehicle width direction.

According to the first aspect, the first seat, including the first seat cushion on which a driver sits and the first seatback configured to support the back of a driver, is disposed centrally in the vehicle width direction inside the vehicle cabin. This enables a predetermined space to be secured at both vehicle width direction sides of the first seat.

Further, the pair of second seats at the vehicle rear of the first seat, each including the second seat cushion on which an occupant sits and the second seatback configured to support the back of an occupant, are disposed at the vehicle rear of the first seat so as to be separated from each other in the vehicle width direction. This enables a driver seated on the first seat and occupants seated on the second seats to sit with their legs in a stretched out state.

It is conceivable that were the first seat and the second seat to be disposed such that the first seat cushion and the second seat cushion overlap each other as viewed along the vehicle width direction, there would be insufficient space secured for each of a driver seated on the first seat and occupants seated on the second seats.

However, in the present disclosure, the pair of second seats are each disposed adjacent to the first seat such that the second seat cushion does not overlap the first seat cushion of the first seat as viewed along the vehicle width direction. A driver seated on the first seat and occupants seated on the second seats can accordingly sit such that at least the upper body of the driver and the upper bodies of the respective occupants do not overlap each other as viewed along the vehicle width direction.

A vehicle seat placement structure according to a second aspect is the first aspect, further including a third seat and a pair of fourth seats. The third seat includes a third seat cushion on which an occupant sits and a third seatback configured to support the back of an occupant, and is disposed at the vehicle rear of the second seat, adjacent to the second seats such that the third seat cushion does not overlap the second seat cushions as viewed along the vehicle width direction, and so as to overlap the first seat as viewed along a vehicle front-rear direction. The pair of fourth seats, each including a fourth seat cushion on which an occupant sits and a fourth seatback configured to support the back of an occupant, are arranged in the vehicle width direction at the vehicle rear of the third seat, and are each disposed adjacent to the third seat such that the fourth seat cushion does not overlap the third seat cushion as viewed along the vehicle width direction and such that a portion of each of the fourth seats further to a vehicle width direction outer side than a vehicle width direction central portion does not overlap the third seat as viewed along the vehicle front-rear direction.

According to the second aspect, the third seat, including the third seat cushion on which an occupant sits and the third seatback configured to support the back of an occupant, is provided at the vehicle rear of the second seat. The third seat is disposed adjacent to the second seats such that the third seat cushion does not overlap the second seat cushions as viewed along the vehicle width direction, and so as to overlap the first seat as viewed along the vehicle front-rear direction.

Further, the pair of fourth seats, each including the fourth seat cushion on which an occupant sits and the fourth seatback configured to support the back of an occupant, are arranged in the vehicle width direction at the vehicle rear of the third seat. The fourth seats are each disposed adjacent to the third seat such that the fourth seat cushion does not overlap the third seat cushion as viewed along the vehicle width direction and such that the portion of each of the fourth seats further to the vehicle width direction outer side than the vehicle width direction central portion does not overlap the third seat as viewed along the vehicle front-rear direction.

Accordingly, in the present disclosure, the number of vehicle occupants can be increased by providing the third seat and the fourth seats at the vehicle rear of the second seats, and space can be secured at the vehicle front of the respective occupants when the occupants are seated.

A vehicle seat placement structure according to a third aspect is the second aspect, wherein each of the second seats is configured to rotate about an axis along a vehicle vertical direction so as to enable an occupant seated on the second seat to face an occupant seated on the fourth seat in the vehicle front-rear direction. In the third seat, the third seatback is capable of tilting toward the third seat cushion, and a face on a vehicle upper side of the third seatback when in a tilted state is provided with an article-placement section enabling placement of articles thereon.

According to the third aspect, the pair of second seats are each configured to rotate about an axis along the vehicle vertical direction so as to enable an occupant seated on the second seat to face an occupant seated on the fourth seat in the vehicle front-rear direction. Further, in the third seat, articles can be placed on the article-placement section provided to the face on the vehicle upper side of the third seatback in a state in which the third seatback is tilted toward the third seat cushion. Accordingly, the present disclosure enables occupants seated on the second seats and occupants seated on the fourth seats to use the third seat as a table.

A vehicle seat placement structure according to a fourth aspect is the second aspect or third aspect, wherein the first seat is configured to rotate about an axis along a vehicle vertical direction so as to enable a driver seated on the first seat to face an occupant seated on the third seat in the vehicle front-rear direction. Each of the second seats is configured to rotate about an axis along the vehicle vertical direction so as to enable an occupant seated on one of the second seats to face an occupant seated on the other second seat in the vehicle width direction.

According to the fourth aspect, the first seat is configured to rotate about an axis along the vehicle vertical direction so as to enable a driver seated on the first seat to face an occupant seated on the third seat in the vehicle front-rear direction. Further, each of the pair of second seats is configured to rotate about an axis along the vehicle vertical direction so as to enable an occupant seated on one of the second seats to face an occupant of the other second seat. The present disclosure thereby enables four occupants including a driver to have a conversation while looking at each other.

A vehicle according to a fifth aspect is a vehicle applied with the vehicle seat placement structure according to any one of the first aspect to the fourth aspect. The vehicle includes a floor panel, a power unit, and an electrical power supply section. The floor panel includes a first panel section configuring part of a floor of the vehicle cabin and on which the first seat is disposed, and a second panel section disposed further to the vehicle rear than the first panel section and further to a vehicle upper side than the first panel section and on which the second seat is disposed. The power unit is driven by electrical power, and is disposed at a vehicle lower side of the floor panel and further to the vehicle rear than the first seat. The electrical power supply section supplies electrical power to the power unit, and is disposed at a vehicle lower side of the second panel section.

According to the fifth aspect, the vehicle seat placement structure according to any one of the first aspect to the fourth aspect is applied, enabling a driver seated on the first seat and occupants seated on the second seats to be seated such that at least the upper body of the driver and the upper bodies of the occupants do not overlap each other as viewed along the vehicle width direction. Further, the vehicle according to the present disclosure includes the power unit that is driven by electrical power and the electrical power supply section that supplies electrical power to the power unit, enabling the vehicle according to the present disclosure to travel using electrical power.

Note that were configuration to be made such that an engine compartment is disposed at the vehicle front, a seat on which a driver sits would need to be disposed further to the vehicle rear than the engine compartment, and this would make it difficult to suppress the overall length of the vehicle.

In the present disclosure, however, the power unit is disposed at the vehicle lower side of the floor panel configuring part of the floor of the vehicle cabin and further to the vehicle rear than the first seat. Thus, the position of the first seat on which a driver is seated can be set further to the vehicle front than in a configuration in which an engine compartment is disposed at the vehicle front. As a result, the overall length of the vehicle can be made shorter while maintaining space within the vehicle cabin.

Moreover, in the present disclosure, the floor panel includes the first panel section and the second panel section, and the second panel section is disposed further to the vehicle rear than the first panel section and further to the vehicle upper side than the first panel section. This enables space to be formed at the vehicle lower side of the second panel section. In the present disclosure, the electrical power supply section is disposed in a space at the vehicle lower side of the second panel section.

Moreover, in the present disclosure, the first seat is disposed on the first panel section and the second seat is disposed on the second panel section. This enables a seating position of an occupant seated on the second seat positioned at the vehicle rear of the first seat to be configured higher than a seating position of a driver seated on the first seat.

A vehicle according to a sixth aspect is a vehicle applied with the vehicle seat placement structure according to any one of the second aspect to the fourth aspect. The vehicle includes a floor panel, a power unit, and an electrical power supply section. The floor panel includes a first panel section configuring part of a floor of the vehicle cabin and on which the first seat is disposed, a second panel section disposed further to the vehicle rear than the first panel section and further to a vehicle upper side than the first panel section and on which the second seat is disposed, a third panel section disposed further to the vehicle rear than the second panel section and further to the vehicle upper side than the second panel section and on which the third seat is disposed, and a fourth panel section disposed further to the vehicle rear than the third panel section and further to the vehicle upper side than the third panel section and on which the fourth seat is disposed. The power unit is driven by electrical power, and is disposed at a vehicle lower side of the fourth panel section. The electrical power supply section supplies electrical power to the power unit, and is disposed at the vehicle lower side of the second panel section and the third panel section.

According to the sixth aspect, the vehicle seat placement structure according to any one of the second aspect to the fourth aspect is applied, enabling space to be secured at the vehicle front of the respective occupants even with an increase in the number of vehicle occupants. Further, since configuration is basically the same as in the fifth aspect of the present disclosure, similar operation to that of the fifth aspect is exhibited.

Moreover, in the sixth aspect, the third panel section and the fourth panel section are further provided to the floor panel, and the third panel section is disposed further to the vehicle rear than the second panel section and further to the vehicle upper side than the second panel section. Moreover, the fourth panel section is disposed further to the vehicle rear than the third panel section and further to the vehicle upper side than the third panel section. Accordingly, the present disclosure enables space to also be formed at the vehicle lower side of the third panel section and the fourth panel section.

Further, as referenced against the first panel section, the respective lengths in the vehicle vertical direction of a space at the vehicle lower side of the second panel section, a space at the vehicle lower side of the third panel section, and a space at the vehicle lower side of the fourth panel section become longer in this sequence. In the present disclosure, the electrical power supply section is disposed at the vehicle lower side of the second panel section and the third panel section, and the power unit that tends to have a larger vehicle vertical direction dimension than that of the electrical power supply section is disposed at the vehicle lower side of the fourth panel section.

Moreover, in the present disclosure, the first seat, the second seats, the third seat, and the fourth seats are respectively disposed on the first panel section, the second panel section, the third panel section, and the fourth panel section. Thus, the seating positions of occupants seated on each seat can be raised in this sequence, such that a seating position of an occupant seated toward the vehicle rear can be made higher than a seating position of an occupant seated toward the vehicle front.

As explained above, the vehicle seat placement structure according to the first aspect has the excellent advantageous effect of enabling space to be secured for occupants respectively seated on the driver seat and the rear seats, enabling comfort of the occupants to be secured.

The vehicle seat placement structure according to the second aspect has the excellent advantageous effect of enabling comfort of occupants to be secured while accommodating an increase in the number of occupants.

The vehicle seat placement structure according to the third aspect has the excellent advantageous effect of enabling convenience to be raised inside the vehicle cabin.

The vehicle seat placement structure according to the fourth aspect has the excellent advantageous effect of enabling increased variation in the utilization of space within the vehicle cabin.

The vehicle according to the fifth aspect has the excellent advantageous effect of utilizing space at the vehicle lower side effectively, enabling the overall length of the vehicle to be suppressed while the field of view and space for each occupant is secured and comfort of the occupants is secured.

The vehicle according to the sixth aspect has advantageous effects similar to those of the fifth aspect, and in addition to these advantageous effects, also has the excellent advantageous effect of enabling more effective utilization of space at the vehicle lower side while accommodating an increase in the number of occupants.

### BRIEF DESCRIPTION OF THE DRAWINGS

FIG. 1 is a plan view illustrating a vehicle applied with a vehicle seat placement structure according to a present exemplary embodiment, in a state in which seats are disposed in a first mode;

FIG. 2 is a plan view illustrating a vehicle applied with a vehicle seat placement structure according to the present exemplary embodiment, in a state in which seats are disposed in a second mode;

FIG. 3 is a plan view illustrating a vehicle applied with a vehicle seat placement structure according to the present exemplary embodiment, in a state in which seats are disposed in a third mode;

FIG. 4 is a plan view illustrating a vehicle applied with a vehicle seat placement structure according to the present exemplary embodiment, in a state in which seats are disposed in a fourth mode; and

FIG. 5 is a side view illustrating a vehicle applied with a vehicle seat placement structure according to the present exemplary embodiment, in a state in which seats are disposed in a first mode.

### DETAILED DESCRIPTION

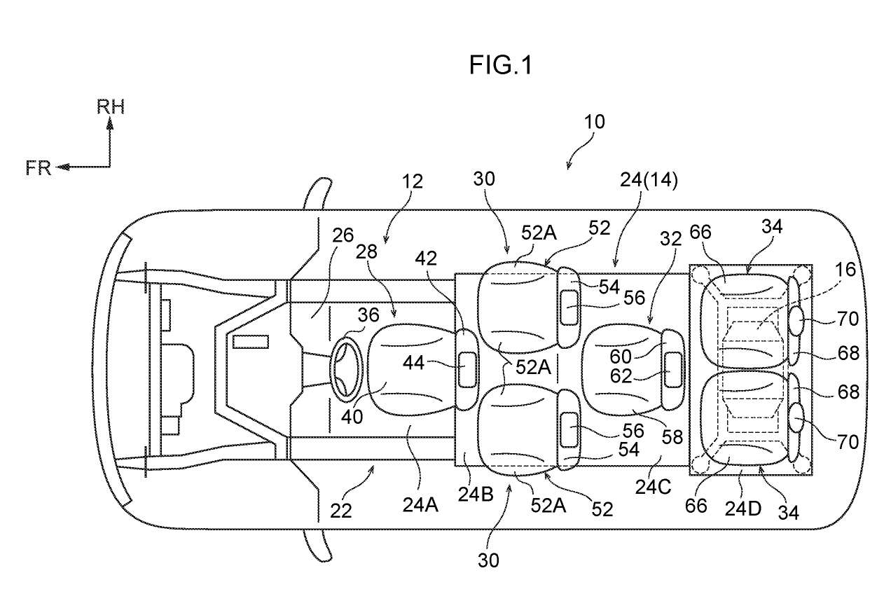

Explanation follows regarding an example of an exemplary embodiment of a vehicle seat placement structure according to the present disclosure, with reference to FIG. 1 to FIG. 5. Note that in each of the drawings, the arrow FR indicates the vehicle front, the arrow UP indicates the vehicle upper side, and the arrow RH indicates the vehicle width direction right side, as appropriate.

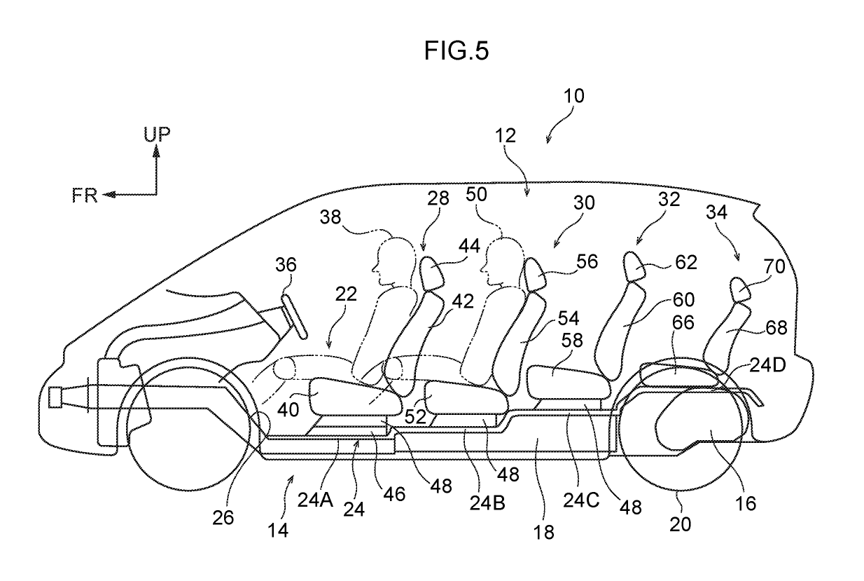

First, explanation follows regarding a schematic configuration of a vehicle 10 that is applied with the vehicle seat placement structure according to the present exemplary embodiment, with reference to FIG. 5. Note that in the present exemplary embodiment, the vehicle 10 is a minivan type and is basically configured with left-right symmetry.

The vehicle 10 is configured including a vehicle body 14 mainly configuring a vehicle cabin 12, a motor 16 serving as a power unit that is attached to the vehicle body 14, and a battery 18 serving as an electrical power supply section that is likewise attached to the vehicle body 14. The motor 16 is driven by receiving electrical power supplied from the battery 18. Drive force generated by the motor 16 is transmitted to rear wheels 20 (drive wheels) through a gearbox or the like, not illustrated in the drawings. Namely, the vehicle 10 travels basically by driving of the rear wheels 20 using the motor 16. An engine is not installed in the vehicle 10 nor is an engine compartment provided to the vehicle 10.

The vehicle body 14 is configured including a floor panel 24 configuring part of a floor 22 of the vehicle cabin 12. The floor panel 24 is formed by pressing a steel sheet and is configured by a first panel section 24A, a second panel section 24B, a third panel section 24C, and a fourth panel section 24D disposed in this sequence from the vehicle front in plan view.

Specifically, the first panel section 24A, the second panel section 24B, the third panel section 24C, and the fourth panel section 24D are each configured in a plate shape extending along a vehicle front-rear direction and a vehicle width direction. The first panel section 24A configures a portion corresponding to approximately the vehicle front quarter of the floor panel 24, and a vehicle front portion thereof is connected to a dashboard 26. Note that a steering mechanism, not illustrated in the drawings, is disposed at a vehicle lower side of the dashboard 26.

The second panel section 24B is provided contiguous to the first panel section 24A, configures a section corresponding to approximately one quarter of the floor panel 24 at the vehicle rear of the first panel section 24A, and is disposed further to the vehicle upper side than the first panel section 24A. Further, the third panel section 24C is provided contiguous to the second panel section 24B, configures a section corresponding to approximately one quarter of the floor panel 24, at the vehicle rear of the second panel section 24B, and is disposed further to the vehicle upper side than the second panel section 24B. The battery 18 is disposed at the vehicle lower side of the second panel section 24B and of the third panel section 24C. Note that as viewed along the vehicle width direction, the battery 18 is configured with a step shape having a vehicle rear portion thickness thicker than a vehicle front portion thickness and is configured in a shape corresponding to the shape of a space at the vehicle lower side of the second panel section 24B and the third panel section 24C.

On the other hand, the fourth panel section 24D is provided contiguous to the third panel section 24C, configures a portion corresponding to approximately the vehicle rear fourth of the floor panel 24, and is disposed further to the vehicle upper side than the third panel section 24C. The motor 16 is disposed at the vehicle lower side of the fourth panel section 24D.

Note that the present exemplary embodiment features a characteristic configuration and placement of a first seat 28 (referred to below as the seat 28), second seats 30 (referred to below as the seats 30), a third seat 32 (referred to below as the seat 32), and fourth seats 34 (referred to below as the seats 34) disposed inside the vehicle cabin 12. Detailed explanation followers regarding configuration and placement of the seats 28, 30, 32, and 34 configuring relevant portions of the present exemplary embodiment. Note that as described later, it is possible for these seats to adopt plural placement modes. However, unless specifically stated otherwise, in the following explanation each seat is disposed in a first mode (see FIG. 1 and FIG. 5), this being a travel mode.

As illustrated in FIG. 1 and FIG. 5, a steering wheel 36 is disposed at the vehicle front of the seat 28, and the seat 28 is configured by a driver seat in which a driver 38 sits. The seat 28 is configured including a first seat cushion 40 that supports the buttocks and thighs of the driver 38, a first seatback 42 that supports the back of the driver 38, and a headrest 44 that supports the head of the driver 38. Note that hereafter, the first seat cushion 40 is referred to as the seat cushion 40 and the first seatback 42 is referred to as the seatback 42. The headrest 44 is supported by a vehicle upper end of the seatback 42 so as to be capable of moving up and down, and the seatback 42 is supported by a vehicle rear end of the seat cushion 40 so as to be capable of tilting. The seat 28 is attached to the floor 22 through a slide mechanism 46 and a rotation mechanism 48.

The slide mechanism 46 includes a pair of left and right lower rails, a pair of left and right upper rails corresponding to the lower rails, and an actuator, none of which are illustrated in the drawings. The lower rails are respectively fixed to the floor 22 with their length directions in the vehicle front-rear direction. On the other hand, the respective left and right upper rails are supported so as to be capable of sliding in the vehicle front-rear direction with respect to the lower rails, and are attached to the rotation mechanism 48 supporting the seat 28 from a vehicle lower side of the seat cushion 40. Using drive force from the actuator, the seat 28, the rotation mechanism 48 attached to the seat 28, and the upper rails are configured so as to be capable of moving in the vehicle front-rear direction relative to the lower rails and consequently relative to the floor 22.

The rotation mechanism 48 is configured including a rotation plate, a gear that rotates together as a unit with the rotation plate, a motor that includes a pinion gear corresponding to the gear, and a support frame that supports each of these, none of which are illustrated in the drawings. The gear is disposed at the vehicle lower side of the rotation plate with the support frame interposed therebetween, plural outer teeth are provided to an outer peripheral portion of the gear, and the gear engages with the pinion gear of the motor. By driving the motor, the seat 28, the rotation plate attached to the seat 28, and the gear are capable of rotating relative to the floor 22 about an axis along the vehicle vertical direction.

The seat 28 is disposed centrally in the vehicle width direction inside the vehicle cabin 12, specifically, at a vehicle width direction central portion of the first panel section 24A. Lopsided load from the weight of the driver 38 is thereby not liable to arise in the vehicle 10 during travel.

On the other hand, the seats 30, on each of which an occupant 50 sits, each include a second seat cushion 52, a second seatback 54, and a headrest 56 and has basically the same configuration as the seat 28. Note that hereafter, the second seat cushion 52 is referred to as the seat cushion 52 and the second seatback 54 is referred to as the seatback 54. Slide mechanisms 46 are not provided to the seats 30. Each seat 30 is attached to the floor 22 through a rotation mechanism 48 and is capable of rotating relative to the floor 22 about an axis along the vehicle vertical direction.

The seats 30 are configured in a left and right pair and are disposed on the second panel section 24B at a predetermined spacing from each other so as to be symmetrical about a center line of the vehicle 10 extending in the vehicle front-rear direction. Namely, the seats 30 are disposed at the vehicle rear of the seat 28, in a state separated from each other in the vehicle width direction.

Further, the seats 30 are adjacent to the seat 28 such that the seat cushions 52 do not overlap the seat cushion 40 as viewed along the vehicle width direction. Moreover, each seat 30 is disposed such that at least a vehicle width direction inner side portion thereof, more specifically, out of a pair of side support portions 52A that bulge out toward the vehicle upper side of the seat cushion 52, a portion where the side support portion 52A on the vehicle width direction inner side is provided, is disposed so as to overlap the seat 28 as viewed along the vehicle front-rear direction.

A seat 32 is configured for use by an occupant 50, has the same configuration as the seats 30, and is configured including a third seat cushion 58, a third seatback 60, and a headrest 62. Note that hereafter, the third seat cushion 58 is referred to as the seat cushion 58 and the third seatback 60 is referred to as the seatback 60. The seat 32 is attached to the floor 22 through a rotation mechanism 48, similarly to the seats 30. The seat 32 is capable of rotating relative to the floor 22 about an axis along the vehicle vertical direction.

The seat 32 is adjacent to the seats 30 and at the vehicle rear of the seats 30 such that the seat cushion 58 does not overlap the seat cushions 52 as viewed along the vehicle width direction. A vehicle width direction position of the seat 32 is set at a vehicle width direction central portion of the third panel section 24C such that the seat 32 overlaps the seat 28 as viewed along the vehicle front-rear direction. Note that the spacing between the seats 30, described above, is set to a length accommodating the legs of an occupant 50 in a state in which the occupant 50 is seated on the seat 32.

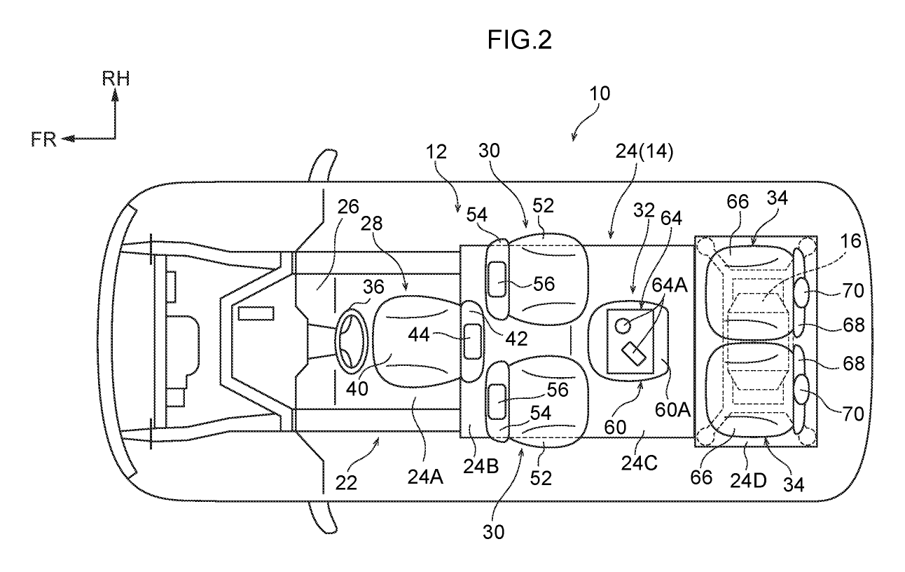

As illustrated in FIG. 2, a tray section 64, serving as an article-placement section, is provided to a back face 60A of the seatback 60, namely, a face on the vehicle upper side of the seatback 60 when in a tilted state toward the seat cushion 58. The tray section 64 is configured from resin, is basically configured in a rectangular plate shape in plan view, and is formed with plural recesses 64A having various shapes. Accordingly, in a state in which the seatback 60 has been tilted toward the seat cushion 58, various articles can be placed on the vehicle upper side of the tray section 64.

Returning to FIG. 1, each of the seats 34 is configured for use by an occupant 50, has the same configuration as the seat 30, and is configured including a fourth seat cushion 66, a fourth seatback 68, and a headrest 70. Note that hereafter, the fourth seat cushion 66 is referred to as the seat cushion 66 and the third seatback 68 is referred to as the seatback 68.

The seats 34 are configured in a left and right pair arranged on the fourth panel section 24D, namely, at the vehicle rear of the seats 32, in a state adjoined to each other in the vehicle width direction so as to be symmetrical about a central line of the vehicle 10 extending in the vehicle front-rear direction. More specifically, as illustrated in FIG. 5, the seats 34 are adjacent to the seat 32 such that the seat cushions 66 do not overlap the seat cushion 58 as viewed along the vehicle width direction. Moreover, the seats 34 are respectively disposed such that the seat cushions 66 are close together and such that for each seat 34, at least a portion further to the vehicle width direction outer side than a vehicle width direction central portion does not overlap the seat 32 as viewed along the vehicle front-rear direction. Note that the seats 34 may be disposed such that the seat cushions 66 are touching each other or may be disposed such that the seat cushions 66 are separated from each other in the vehicle width direction.

Operation and Advantageous Effects of the Present Exemplary Embodiment.

Next, explanation follows regarding operation and advantageous effects of the present exemplary embodiment.

As illustrated in FIG. 1 and FIG. 5, in the present exemplary embodiment, the seat 28, including the seat cushion 40 on which the driver 38 sits and the seatback 42 that supports the back of the driver 38, is disposed centrally in the vehicle width direction inside the vehicle cabin 12. This enables a predetermined space to be secured at both vehicle width direction sides of the seat 28.

The pair of seats 30 at the vehicle rear of the seat 28, each including the seat cushion 52 on which an occupant 50 sits and the seatback 54 that supports the back of the occupant 50, are disposed at the vehicle rear of the seat 28 so as to be separated from each other in the vehicle width direction. The driver 38 seated on the seat 28 and the occupants 50 seated on the seats 30 can accordingly sit with their legs in a stretched out state.

Note that were the seat 28 and the seats 30 to be disposed such that the seat cushion 40 and the seat cushions 52 overlap each other as viewed along the vehicle width direction, is it conceivable that there would be insufficient space secured for the driver 38 and the occupants 50 seated on the seats 30.

However, in the present exemplary embodiment, the pair of seats 30 are disposed adjacent to the seat 28 such that the seat cushions 52 do not overlap the seat cushion 40 of the seat 28 as viewed along the vehicle width direction. This enables the driver 38 and the occupants 50 seated on the seats 30 to be seated such that at least the upper body of the driver 38 and the upper bodies of the occupants 50 do not overlap each other as viewed along the vehicle width direction. Thus, in the present exemplary embodiment, space can be secured for the occupants respectively seated on the driver seat and the rear seats, enabling comfort of the occupants to be secured.

Moreover, by disposing the seat 28 and the seats 30 as described above, even if an occupant 50 seated on a seat 30 moves in the vehicle width direction in a side-on collision involving the vehicle 10, the seat 28 is not positioned on the trajectory of at least the upper body of the occupant 50. Namely, the positional relationship between the seat 28 and the seats 30 also contributes to the safety of the driver 38 and the occupants 50.

In the present exemplary embodiment, the seat 32, including the seat cushion 58 on which an occupant 50 sits and the seatback 60 that supports the back of the occupant 50, is provided at the vehicle rear of the seats 30. The seat 32 is disposed adjacent to the seats 30 such that the seat cushion 58 and the seat cushions 52 do not overlap each other as viewed along the vehicle width direction, and the seat 32 is disposed so as to overlap the seat 28 as viewed along the vehicle front-rear direction.

The pair of seats 34, each including the seat cushion 66 on which an occupant 50 sits and the seatback 68 that supports the back of the occupant 50, are arranged at the vehicle rear of the seat 32 and adjoined to each other in the vehicle width direction. The seats 34 are adjacent to the seat 32 such that the seat cushions 66 do not overlap the seat cushion 58 as viewed along the vehicle width direction, and each seat 34 is disposed such that the portion further to the vehicle width direction outer side than the vehicle width direction central portion does not overlap the seat 32 as viewed along the vehicle front-rear direction.

In the present exemplary embodiment, this enables the number of occupants of the vehicle 10 to be increased by providing the seat 32 and the seats 34 at the vehicle rear of the seats 30, and enables space to be secured at the vehicle front of the respective occupants when the occupants are seated. Thus, the present exemplary embodiment enables the comfort of occupants to be secured while accommodating an increase in the number of occupants.

As illustrated in FIG. 2, in the present exemplary embodiment, the seats 28, 30, 32, and 34 can be placed in a second mode. More specifically, occupants 50 seated on the seats 30 can face occupants 50 seated on the seats 34 in the vehicle front-rear direction by rotating each of the pair of seats 30 about an axis along the vehicle vertical direction. Further, tilting the seatback 60 of the seat 32 toward the seat cushion 58 enables articles to be placed on the tray section 64. Thus, in the present exemplary embodiment, the occupants 50 seated on the seats 30 and the occupants 50 seated on the seats 34 can use the seat 32 as a table. The present exemplary embodiment thereby enables convenience to be raised inside the vehicle cabin 12.

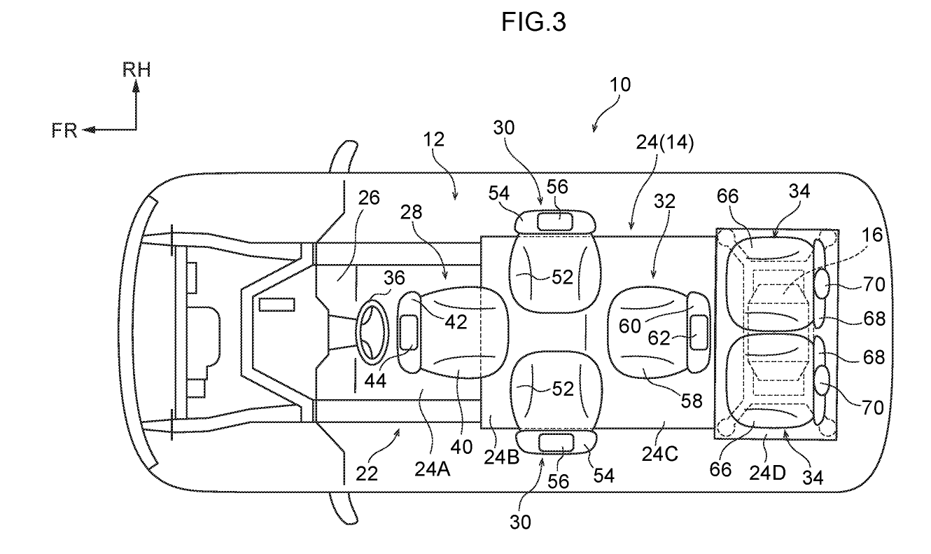

As illustrated in FIG. 3, in the present exemplary embodiment, the seats 28, 30, 32, and 34 can be placed in a third mode. More specifically, the driver 38 seated on the seat 28 can face an occupant 50 seated on the seat 32 in the vehicle front-rear direction by rotating the seat 28 about an axis along the vehicle vertical direction. Further, an occupant 50 seated on one of the seats 30 can face an occupant 50 of the other seat 30 by rotating each of the pair of seats 30 about an axis along the vehicle vertical direction. The present exemplary embodiment thereby enables four occupants including the driver 38 to have a conversation while looking at each other, and as a result, enabling increased variation in the utilization of space within the vehicle cabin.

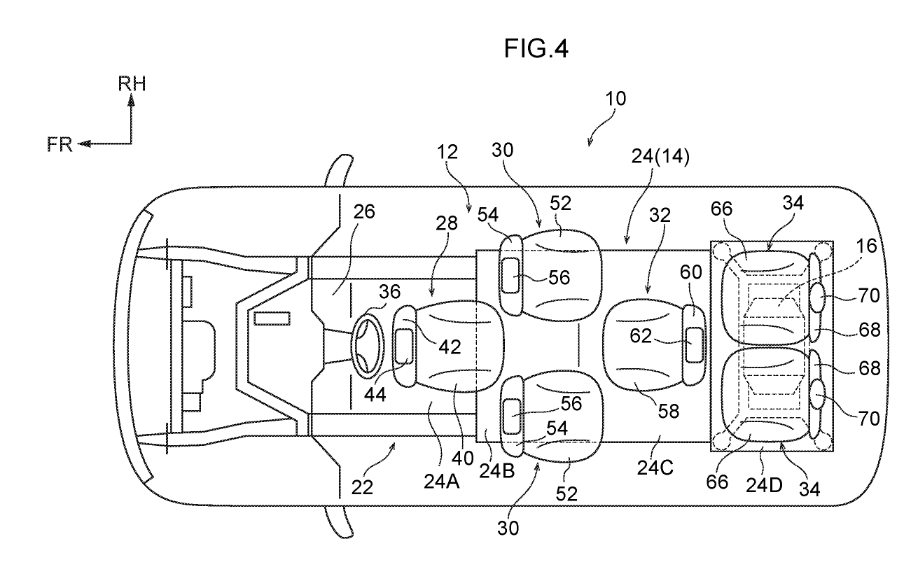

As illustrated in FIG. 4, in the present exemplary embodiment, the seats 28, 30, 32, and 34 can be placed in a fourth mode. More specifically, the occupants seated on the seats 28, 30 and the occupants seated on the seats 32, 34 can face each other in a three-on-three state by rotating the seats 30 from the third mode state such that the occupants 50 seated on the seats 30 face the vehicle rear. Due to configuration in which the seats 28, 30, 32, and 34 are capable of being placed in the second mode to the fourth mode as described above, the driver 38 and the occupants 50 can pass their time in the vehicle cabin 12 more comfortably while, for example, the battery 18 is charging or the like.

In the present exemplary embodiment, the vehicle 10 includes the motor 16 driven by electrical power and the battery 18 that supplies electrical power to the motor 16, and the vehicle 10 is capable of traveling using electrical power. Note that were an engine to be provided to the vehicle 10 and the vehicle 10 configured with an engine compartment disposed at the vehicle front, the seat on which a driver sits would need to be disposed further to the vehicle rear than the engine compartment, and this would make it difficult to suppress the overall length of the vehicle.

However, in the present exemplary embodiment, the motor 16 is disposed further to the vehicle rear than the seat 28, and at the vehicle lower side of the floor panel 24 configuring part of the floor 22 of the vehicle cabin 12. Thus, the position of the seat 28 in which the driver 38 is seated can be set further to the vehicle front than in a configuration in which an engine compartment is disposed at the vehicle front. As a result, the overall length of the vehicle can be made shorter while maintaining space within the vehicle cabin 12.

Further, in the present exemplary embodiment, the floor panel 24 includes the first panel section 24A and the second panel section 24B. The second panel section 24B is disposed further to the vehicle rear than the first panel section 24A and further to the vehicle upper side than the first panel section 24A. This enables space to be formed at the vehicle lower side of the second panel section 24B. The battery 18 is disposed in the space at the vehicle lower side of the second panel section 24B.

Moreover, in the present exemplary embodiment, the seat 28 is disposed on the first panel section 24A, and the seats 30 are disposed on the second panel section 24B. This enables the seating position of an occupant 50 seated on the seat 30 positioned at the vehicle rear of the seat 28 to be configured higher than the seating position of the driver 38 seated on the seat 28. Accordingly, in the present exemplary embodiment, by effectively utilizing space at the vehicle lower side, the overall length of the vehicle can be suppressed while the field of view and space for each occupant is secured such that comfort of the occupants is secured.

Further, in the present exemplary embodiment, the third panel section 24C and the fourth panel section 24D are provided to the floor panel 24, and the third panel section 24C is disposed further to the vehicle rear than the second panel section 24B and further to the vehicle upper side than the second panel section 24B. On the other hand, the fourth panel section 24D is disposed further to the vehicle rear than the third panel section 24C and further to the vehicle upper side than the third panel section 24C. Thus, in the present exemplary embodiment, space is also formed at the vehicle lower side of the third panel section 24C and the fourth panel section 24D.

As referenced against the first panel section 24A, the respective lengths in the vehicle vertical direction of the space at the vehicle lower side of the second panel section 24B, the space at the vehicle lower side of the third panel section 24C, and the space at the vehicle lower side of the fourth panel section 24D first panel section become longer in this sequence. In the present exemplary embodiment, the battery 18 is disposed at the vehicle lower side of the second panel section 24B and the third panel section 24C, and the motor 16 that tends to have a larger vehicle vertical direction dimension than that of the battery 18, is disposed at the vehicle lower side of the fourth panel section 24D.

Moreover, in the present exemplary embodiment, the seat 28, the seats 30, the seat 32, and the seats 34 are respectively disposed on the first panel section 24A, the second panel section 24B, the third panel section 24C, and the fourth panel section 24D. Thus, the seating position of an occupant seated on each seat becomes higher in this sequence, such that the seating position of an occupant seated toward the vehicle rear can be made higher than the seating position of an occupant seated toward the vehicle front. Accordingly, in the present exemplary embodiment, space at the vehicle lower side can be even more effectively utilized while accommodating an increase in the number of occupants.

Supplementary Explanation of the Exemplary Embodiment Above

(1) In the exemplary embodiment described above, the seats 28, 30, 32, and 34 can be placed in four modes; however, configuration may be made in which at least two of the modes are adopted, with one of these two modes being the first mode. Note that in cases in which configuration is made in which only the first mode is adopted, the rotation mechanisms 48 may be omitted.

(2) Further, in the exemplary embodiment described above, the seats 30, 32, and 34 are not provided with the slide mechanism 46; however, configuration may be made in which slide mechanisms 46 are provided thereto, such that the vehicle front-rear direction positions thereof are adjustable.

(3) Further, in the exemplary embodiment described above, the vehicle seat placement structure according to the present exemplary embodiment is applied to the minivan type vehicle 10; however, there is no limitation thereto. For example, the placement structure of the seats 28, 30 may be applied to a compact car containing three seats. In such a configuration also, a driver seated on the seat 28 and occupants seated on the seats 30 can be seated such that at least the upper body of the driver and the upper bodies of the occupants do not overlap each other as viewed along the vehicle width direction. Moreover, this enables configuration to be made such that even if an occupant seated on the seat 30 moves in the vehicle width direction in a vehicle side-on collision, the seat 28 is not positioned on the trajectory of at least the upper body of the occupant.

(4) Further, in the exemplary embodiment described above, the floor panel 24 is configured including the first panel section 24A, the second panel section 24B, the third panel section 24C, and the fourth panel section 24D; however, there is no limitation thereto. For example, configuration may be made in which the floor panel 24 extends uniformly in the vehicle front-rear direction and the vehicle width direction; or in cases in which the placement structure of the seats 28, 30 is applied to a compact car, the floor panel 24 may be configured by the first panel section 24A and the second panel section 24B.

(5) Further, in the exemplary embodiment described above, the seat 34 is disposed such that the seat cushions 66 are close together as viewed along the vehicle front-rear direction. However, configuration may be made in which a portion where an occupant can sit is provided between the seats 34.

(6) Further, in the exemplary embodiment described above, the vehicle seat placement structure according to the present exemplary embodiment is applied to the vehicle 10 that is not installed with an engine. However, the vehicle seat placement structure according to the present exemplary embodiment may be applied to a vehicle that is installed with an engine. In such configurations also, space can be secured for the occupants respectively seated on the driver seat and the rear seats, enabling comfort of the occupants to be secured.

What is claimed is:

1. A vehicle seat placement structure comprising:
a first seat that includes a first seat cushion on which a driver sits and a first seatback configured to support the back of a driver, with the first seat disposed centrally in a vehicle width direction inside a vehicle cabin; and
a pair of second seats that each include a second seat cushion on which an occupant sits and a second seatback configured to support the back of an occupant, that are disposed at a vehicle rear of the first seat so as to be separated from each other in the vehicle width direction, and that are each disposed adjacent to the first seat such that the second seat cushion does not overlap the first seat cushion as viewed along the vehicle width direction.

2. The vehicle seat placement structure of claim 1, further comprising:
a third seat that includes a third seat cushion on which an occupant sits and a third seatback configured to support the back of an occupant, and that is disposed at the vehicle rear of the second seat, adjacent to the second seats such that the third seat cushion does not overlap the second seat cushions as viewed along the vehicle width direction, and so as to overlap the first seat as viewed along a vehicle front-rear direction; and
a pair of fourth seats, each including a fourth seat cushion on which an occupant sits and a fourth seatback configured to support the back of an occupant, are arranged in the vehicle width direction at the vehicle rear of the third seat, and that are each disposed adjacent to the third seat such that the fourth seat cushion does not overlap the third seat cushion as viewed along the vehicle width direction and such that a portion of each of the fourth seats further to a vehicle width direction outer side than a vehicle width direction central portion does not overlap the third seat as viewed along the vehicle front-rear direction.

3. The vehicle seat placement structure of claim 2, wherein:
each of the second seats is configured to rotate about an axis along a vehicle vertical direction so as to enable an occupant seated on the second seat to face an occupant seated on the fourth seat in the vehicle front-rear direction; and
in the third seat, the third seatback is capable of tilting toward the third seat cushion, and a face on a vehicle upper side of the third seatback when in a tilted state is provided with an article-placement section enabling placement of articles thereon.

4. The vehicle seat placement structure according to claim 2, wherein:
the first seat is configured to rotate about an axis along a vehicle vertical direction so as to enable a driver seated on the first seat to face an occupant seated on the third seat in the vehicle front-rear direction; and
each of the second seats is configured to rotate about an axis along the vehicle vertical direction so as to enable an occupant seated on one second seat to face an occupant seated on the other second seat in the vehicle width direction.

5. The vehicle seat placement structure according to claim 3, wherein:
the first seat is configured to rotate about an axis along a vehicle vertical direction so as to enable a driver seated on the first seat to face an occupant seated on the third seat in the vehicle front-rear direction; and
each of the second seats is configured to rotate about an axis along the vehicle vertical direction so as to enable an occupant seated on one second seat to face an occupant seated on the other second seat in the vehicle width direction.

6. A vehicle applied with the vehicle seat placement structure of claim 1, the vehicle comprising:
a floor panel that includes a first panel section configuring part of a floor of the vehicle cabin and on which the first seat is disposed, and a second panel section disposed further to the vehicle rear than the first panel section and further to a vehicle upper side than the first panel section and on which the second seat is disposed;
a power unit that is driven by electrical power, and that is disposed at a vehicle lower side of the floor panel and further to the vehicle rear than the first seat; and
an electrical power supply section that supplies electrical power to the power unit, and that is disposed at a vehicle lower side of the second panel section.

7. A vehicle applied with the vehicle seat placement structure of claim 2, the vehicle comprising:
a floor panel that includes a first panel section configuring part of a floor of the vehicle cabin and on which the first seat is disposed, and a second panel section disposed further to the vehicle rear than the first panel section and further to a vehicle upper side than the first panel section and on which the second seat is disposed;
a power unit that is driven by electrical power, and that is disposed at a vehicle lower side of the floor panel and further to the vehicle rear than the first seat; and
an electrical power supply section that supplies electrical power to the power unit, and that is disposed at a vehicle lower side of the second panel section.

8. A vehicle applied with the vehicle seat placement structure of claim 3, the vehicle comprising:
a floor panel that includes a first panel section configuring part of a floor of the vehicle cabin and on which the first seat is disposed, and a second panel section disposed further to the vehicle rear than the first panel section and further to a vehicle upper side than the first panel section and on which the second seat is disposed;
a power unit that is driven by electrical power, and that is disposed at a vehicle lower side of the floor panel and further to the vehicle rear than the first seat; and
an electrical power supply section that supplies electrical power to the power unit, and that is disposed at a vehicle lower side of the second panel section.

9. A vehicle applied with the vehicle seat placement structure of claim 4, the vehicle comprising:
a floor panel that includes a first panel section configuring part of a floor of the vehicle cabin and on which the first seat is disposed, and a second panel section disposed further to the vehicle rear than the first panel section and further to a vehicle upper side than the first panel section and on which the second seat is disposed;
a power unit that is driven by electrical power, and that is disposed at a vehicle lower side of the floor panel and further to the vehicle rear than the first seat; and
an electrical power supply section that supplies electrical power to the power unit, and that is disposed at a vehicle lower side of the second panel section.

10. A vehicle applied with the vehicle seat placement structure of claim 2, the vehicle comprising:
a floor panel that includes a first panel section configuring part of a floor of the vehicle cabin and on which the first seat is disposed, a second panel section disposed further to the vehicle rear than the first panel section and further to a vehicle upper side than the first panel section and on which the second seat is disposed, a third panel section disposed further to the vehicle rear than the second panel section and further to the vehicle upper side than the second panel section and on which the third seat is disposed, and a fourth panel section disposed further to the vehicle rear than the third panel section and further to the vehicle upper side than the third panel section and on which the fourth seat is disposed;
a power unit that is driven by electrical power, and that is disposed at a vehicle lower side of the fourth panel section; and
an electrical power supply section that supplies electrical power to the power unit, and that is disposed at the vehicle lower side of the second panel section and the third panel section.

11. A vehicle applied with the vehicle seat placement structure of claim 3, the vehicle comprising:
a floor panel that includes a first panel section configuring part of a floor of the vehicle cabin and on which the first seat is disposed, a second panel section disposed further to the vehicle rear than the first panel section and further to a vehicle upper side than the first panel section and on which the second seat is disposed, a third panel section disposed further to the vehicle rear than the second panel section and further to the vehicle upper side than the second panel section and on which the third seat is disposed, and a fourth panel section disposed further to the vehicle rear than the third panel section and further to the vehicle upper side than the third panel section and on which the fourth seat is disposed;
a power unit that is driven by electrical power, and that is disposed at a vehicle lower side of the fourth panel section; and
an electrical power supply section that supplies electrical power to the power unit, and that is disposed at the vehicle lower side of the second panel section and the third panel section.

12. A vehicle applied with the vehicle seat placement structure of claim 4, the vehicle comprising:
a floor panel that includes a first panel section configuring part of a floor of the vehicle cabin and on which the first seat is disposed, a second panel section disposed further to the vehicle rear than the first panel section and further to a vehicle upper side than the first panel section and on which the second seat is disposed, a third panel section disposed further to the vehicle rear than the second panel section and further to the vehicle upper side than the second panel section and on which the third seat is disposed, and a fourth panel section disposed further to the vehicle rear than the third panel section and further to the vehicle upper side than the third panel section and on which the fourth seat is disposed;
a power unit that is driven by electrical power, and that is disposed at a vehicle lower side of the fourth panel section; and
an electrical power supply section that supplies electrical power to the power unit, and that is disposed at the vehicle lower side of the second panel section and the third panel section.
